(19) United States
(12) Patent Application Publication
(10) Pub. No.: US 2013/0147939 A1
(43) Pub. Date: Jun. 13, 2013

(54) IMAGE ACQUISITION APPARATUS AND METHOD FOR ADJUSTING IMAGE ACQUISITION APPARATUS

(71) Applicant: CANON KABUSHIKI KAISHA, Tokyo (JP)

(72) Inventors: Ryo Nawata, Utsunomiya-shi (JP); Yuji Sudoh, Hadano-shi (JP)

(73) Assignee: CANON KABUSHIKI KAISHA, Tokyo (JP)

(21) Appl. No.: 13/707,479

(22) Filed: Dec. 6, 2012

(30) Foreign Application Priority Data
Dec. 9, 2011 (JP) PCT/JP2011/078520

(51) Int. Cl. H04N 7/18

(52) U.S. Cl. 348/79

(57) ABSTRACT

An image acquisition apparatus includes a test object stage that holds a test object, a measuring unit that acquires surface profile information of the test object, and a microscope unit that includes an objective optical system that forms an image of the test object and an image pickup element that captures the image of the test object formed by the objective optical system. The test object stage is movable between a measurement position of the measuring unit and a imaging position of the microscope unit. The measuring unit acquires first stage inclination information of the test object stage. At the imaging position, the test object stage adjusts an orientation thereof on the basis of a relationship between the surface profile information and the first stage inclination information.

### TECHNICAL FIELD

The present invention relates to an image acquisition apparatus including a mechanism capable of adjusting the position and orientation of a test object.

### BACKGROUND ART

In the field of pathology, image acquisition systems including an image acquisition apparatus and a display device are relatively well known. The image acquisition apparatus captures an image of a test object (prepared slide) including a sample to acquire a digital image of the test object. The display device displays the digital image preferably at a high resolution. The image acquisition apparatuses are required to quickly capture a high-resolution image of the test object. To satisfy such a requirement, it is necessary to capture a high-resolution image of a large area of the test object in a single process. Accordingly, a microscope has been proposed which includes a wide-field, high-resolution objective lens and a group of image pickup elements arranged in the field of view of the objective lens so that a plurality of images can be captured at the same time. An example is described in patent literature 1 (PTL 1).

In an image acquisition apparatus, components may become displaced from the designed positions owing to, for example, errors in assembly and installation and thermal expansion of structural materials caused by temperature variation. In addition, when the resolution of the objective lens is increased, the depth of focus is reduced. Therefore, when the test object is inclined with respect to the microscope unit including the objective lens and the image pickup elements, the test object will be partially out of focus in the imaging area. Therefore, in the image acquisition apparatus, it is necessary to appropriately manage the orientation of the test object with respect to the microscope unit to adjust the focus. A microscope device is proposed which is capable of making a photo detector of a line sensor and a plane of a slide glass parallel to each other by adjusting the orientation of the line sensor or the slide glass (PTL 2).

### CITATION LIST

### Patent Literature

PTL 1: Japanese Patent Laid-Open No. 2009-003016
PTL 2: Japanese Patent Laid-Open No. 2010-101959

In a general pathological diagnosis, a prepared slide including a sample to be observed is used as a test object. When the prepared slide is produced, a cover glass and the sample may become deformed. When the surface of the sample is undulated such that a part of the sample in the imaging area cannot be positioned within the depth of focus of the objective lens, blurring due to defocusing occurs in the acquired image. Therefore, it is necessary to adjust the orientation of the prepared slide in consideration of not only the displacements of the components due to installation errors, temperature variation, etc., but also the surface profile (undulation) of the sample. However, according to the method described in PTL 2, the adjustment is performed on the basis of the information of the orientation of the line sensor, the orientation being determined from the states of focus of detection points arranged on the slide glass. Therefore, the prepared slide cannot be adjusted in consideration of the surface profile of the sample.

Accordingly, an object of the present invention is to provide an image acquisition apparatus which includes a wide-field, high-resolution objective optical system and which is capable of acquiring a satisfactory digital image of a sample by suppressing blurring due to defocusing even when the sample has an undulated surface.

### SUMMARY OF INVENTION

To achieve the above-described object, an image acquisition apparatus according to an aspect of the present invention includes a test object stage that holds a test object, a measuring unit that acquires surface profile information of the test object, and a microscope unit that includes an objective optical system that forms an image of the test object and an image pickup element that captures the image of the test object formed by the objective optical system. The test object stage is movable between a measurement position of the measuring unit and a imaging position of the microscope unit. The measuring unit acquires first stage inclination information of the test object stage. At the imaging position, the test object stage adjusts an orientation thereof on the basis of a relationship between the surface profile information and the first stage inclination information.

Further features of the present invention will become apparent from the following description of exemplary embodiments with reference to the attached drawings.

### BRIEF DESCRIPTION OF DRAWINGS

FIG. 1 is a schematic diagram illustrating an image acquisition system 1000 according to an embodiment of the present invention.

FIG. 2 is a schematic diagram illustrating a prepared slide 30 according to the embodiment of the present invention.

FIG. 3 is a schematic diagram illustrating an imaging unit 50 according to the embodiment of the present invention.

FIG. 4 is a diagram illustrating an inclination information measurement performed by a calculation processing unit 4 according to a first embodiment of the present invention.

FIG. 5 is a flowchart illustrating exemplary steps of a method for adjusting a test object stage 20 according to the first embodiment of the present invention.

FIG. 6 is a diagram illustrating a method for calibrating a second measuring means 900 according to the first embodiment of the present invention.

FIG. 7 is a diagram illustrating a method for calibrating a first measuring means 600 according to the first embodiment of the present invention.

FIG. 8 is a diagram illustrating the arrangement of a microscope unit 1 and a measurement unit 2 according to a second embodiment of the present invention.

FIG. 9 is a flowchart illustrating exemplary steps of a method for adjusting a test object stage 20 according to the second embodiment of the present invention.

FIG. 10 is a schematic diagram illustrating a reference prepared slide 31 according to the second embodiment of the present invention.

FIG. 11A is a diagram illustrating a method for acquiring a calibration value Z0 according to the second embodiment of the present invention.

FIG. 11B is a diagram illustrating a focus adjusting method according to the second embodiment of the present invention.

FIG. 12A is a sectional view of a prepared slide 30 in an imaging area according to the second embodiment of the present invention.

FIG. 12B is a sectional view of the prepared slide 30 in the imaging area according to the second embodiment of the present invention.

### DESCRIPTION OF EMBODIMENTS

A preferred embodiment of the present invention will be described with reference to the drawings.

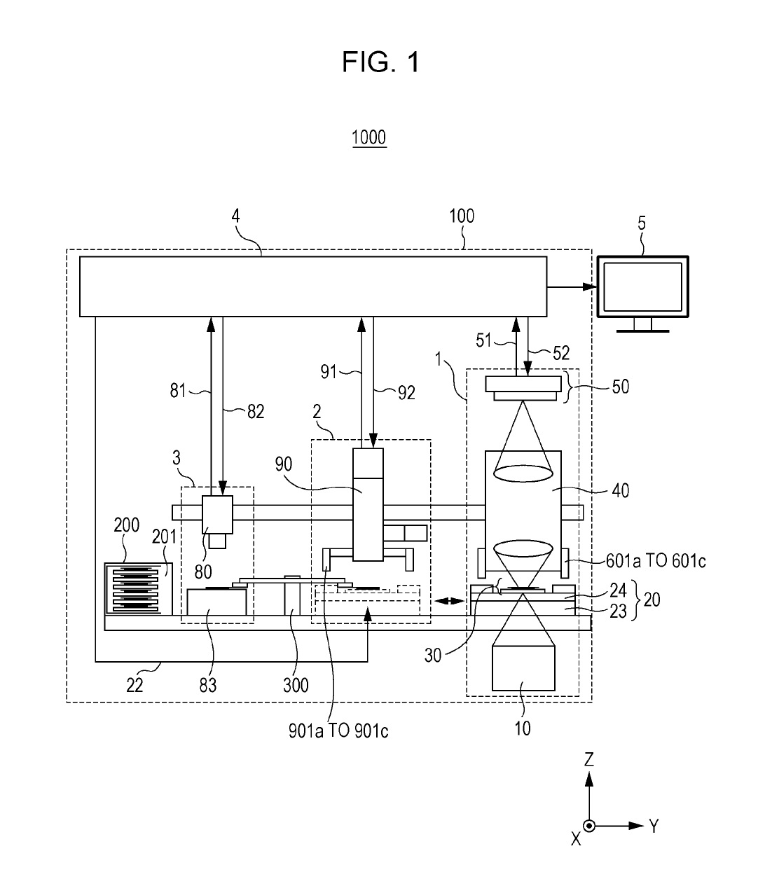

FIG. 1 is a schematic diagram illustrating an image acquisition system 1000 according to the present embodiment. The image acquisition system 1000 includes an image acquisition apparatus 100 that acquires an image of a test object and an image display unit 5 that displays the acquired image. The image acquisition apparatus 100 includes a microscope unit 1, a measurement unit 2, a wide-area imaging unit 3, a calculation processing unit 4, a test object stage 20, and a carry-in-and-out device 200.

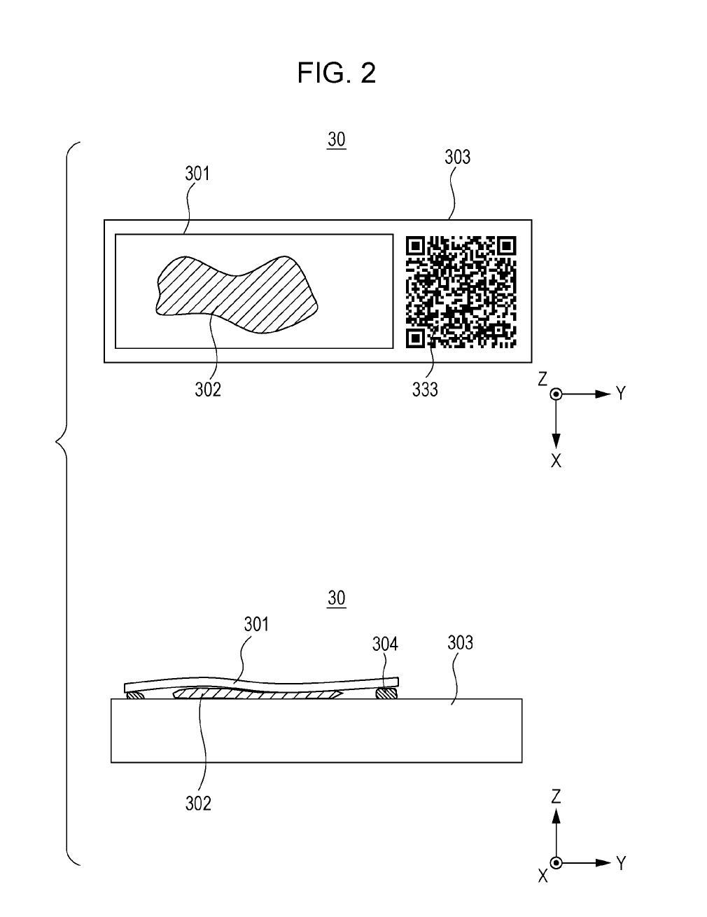

In the present embodiment, a prepared slide 30, which is illustrated in FIG. 2, is used as a test object to be observed. The prepared slide 30 is formed by sealing a sample 302 (e.g., a biological sample such as a tissue section) placed on a slide glass 303 with a cover glass 301 and an adhesive 304. A label 333 may be provided on the slide glass 303. Information required to manage the prepared slide 30 (sample 302), such as an identification number of the slide glass 303 and the thickness of the cover glass 301, is recorded on the label 333.

A procedure by which the image acquisition apparatus 100 acquires an image of the prepared slide 30 will now be descried.

First, a transferring means (not shown) carries the prepared slide 30, which is stored in a storage cabinet 201 of the carry-in-and-out device 200, to a wide-area imaging base 83 of a wide-area imaging unit 3. In the wide-area imaging unit 3, a wide-area imaging camera 80 captures an image of the prepared slide 30 in response to a measurement command 82 transmitted from the calculation processing unit 4. As a result of the measurement performed in the wide-area imaging unit 3, an area (sample area) of the prepared slide 30 in which the sample 302 is located can be determined prior to a measurement process performed in the measurement unit 2 and an image acquisition process performed in the microscope unit 1. The wide-area imaging camera 80 is capable of capturing an image of at least the entire area of the cover glass 301 in the prepared slide 30.

Next, a replacement hand 300 places the prepared slide 30 onto the test object stage 20 while the test object stage 20 is positioned in the measurement unit 2. In the measurement unit 2, a surface profiler 90 measures the surface profile of the prepared slide 30. The surface profiler 90 may be, for example, a Shack-Hartman sensor, an interferometer, or a line sensor. The calculation processing unit 4 transmits a measurement command 92 to the surface profiler 90 on the basis of sample area information 81 acquired by the wide-area imaging unit 3, so that the surface profile of the prepared slide 30 in the sample area can be efficiently measured.

The test object stage 20 is movable while holding the prepared slide 30, and is moved between a measurement position of the measurement unit 2 and a imaging position of the microscope unit 1 in response to a drive command 22 from the calculation processing unit 4. The test object stage 20 includes an XY stage 23 that drives the prepared slide 30 in XY directions and a Z tilt stage 24 that drives the prepared slide 30 in Z, θx, and θy directions. The Z direction is an optical axis direction of an objective optical system 40. The XY directions are directions perpendicular to the optical axis. The θx direction is a rotational direction around the X-axis. The θy direction is a rotational direction around the Y-axis. The position and orientation of the prepared slide 30 can be adjusted by the XY stage 23 and the Z tilt stage 24.

The test object stage 20 holds the prepared slide 30 by means of, for example, leaf springs, vacuum attraction, or electrostatic attraction. For example, in the case where the leaf springs are used, the prepared slide 30 may be pressed in the Z direction in an area outside an imaging area, or side surfaces of the prepared slide 30 may be pressed in the XY directions. In the case where vacuum attraction or electrostatic attraction is used, an attraction force may be applied to a bottom surface of the prepared slide 30 in the area outside the imaging area. Owing to the above-described holding means, the test object stage 20 can move between the measurement position of the measurement unit 2 and the imaging position of the microscope unit 1 while maintaining the state in which the prepared slide 30 is held. Each of the XY stage 23 and the Z tilt stage 24 has a hole for allowing light from an illumination unit 10 included in the microscope unit 1 to pass therethrough and illuminate the prepared slide 30.

The test object stage 20 that holds the prepared slide 30 moves from the measurement position of the measurement unit 2 to the imaging position of the microscope unit 1 in response to the drive command 22 from the calculation processing unit 4. In the microscope unit 1, the illumination unit 10 illuminates the prepared slide 30 and the objective optical system 40 focuses light from the prepared slide 30 onto an imaging unit 50, so that an image of the prepared slide 30 is captured. The calculation processing unit 4 transmits an image pickup command 52 to the imaging unit 50 on the basis of the sample area information 81 acquired by the wide-area imaging unit 3 and surface profile information 91 acquired by the measurement unit 2. Accordingly, the image capturing process can be performed in accordance with the size and profile of the sample 302. Image pickup information 51 acquired by the microscope unit 1 is processed by the calculation processing unit 4, so that an image of the prepared slide 30 is obtained. The image is displayed on the image display unit 5 as necessary.

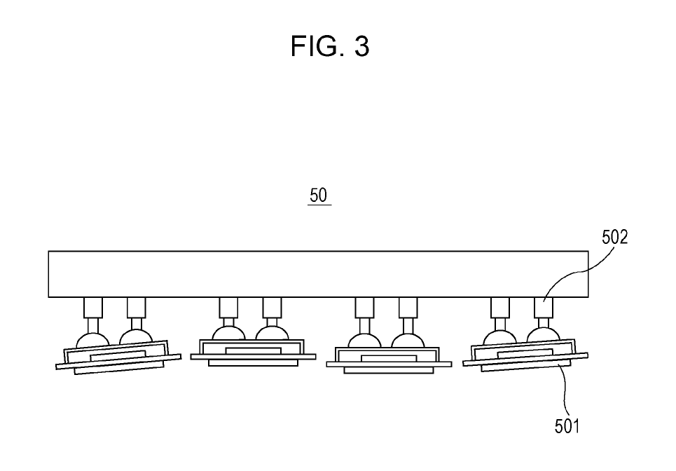

As illustrated in FIG. 3, the imaging unit 50 includes at least one image pickup element 501. The number and arrangement of the image pickup elements 501 may be determined in accordance with the size and profile of the sample 302 as appropriate. Each image pickup element 501 may be provided with a drive mechanism 502 so that the position and orientation of the image pickup element 501 can be changed. In this case, the position and orientation of each image pickup element 501 may be controlled on the basis of the surface profile information 91 of the prepared slide 30 acquired in the measurement unit 2.

The schematic structure of the image acquisition system 1000 according to the present embodiment has been described. Next, a method for adjusting the test object stage 20 according to each embodiment will be described.

### First Embodiment

In the present embodiment, a focus adjustment is performed in the microscope unit 1 by adjusting the orientation of the Z tilt stage 24 of the test object stage 20 in accordance with the displacements of the components and the surface profile of the cover glass 301 of the prepared slide 30. This is because in the case where the objective optical system 40 is a magnifying system, a stroke by which the test object stage 20 is to be driven to perform the focus adjustment in accordance with the surface profile of the cover glass 301 is smaller than that by which the image pickup element 501 is to be driven.

Accordingly, in the image acquisition apparatus 100 according to the present embodiment, the microscope unit 1 and the measurement unit 2 respectively include a first measuring means 600 and a second measuring means 900 for obtaining inclination information of the Z tilt stage 24. With this structure, an approximate plane D of a surface of the cover glass 301 and inclination information of the approximate plane D are determined in the measurement unit 2, and the Z tilt stage 24 is adjusted so that the approximate plane D is perpendicular to an optical axis of the objective optical system 40 in the microscope unit 1. Therefore, the focus adjustment can be performed on the basis of not only the displacements of the components due to, for example, installation errors and temperature variation, but also the surface profile of the cover glass 301.

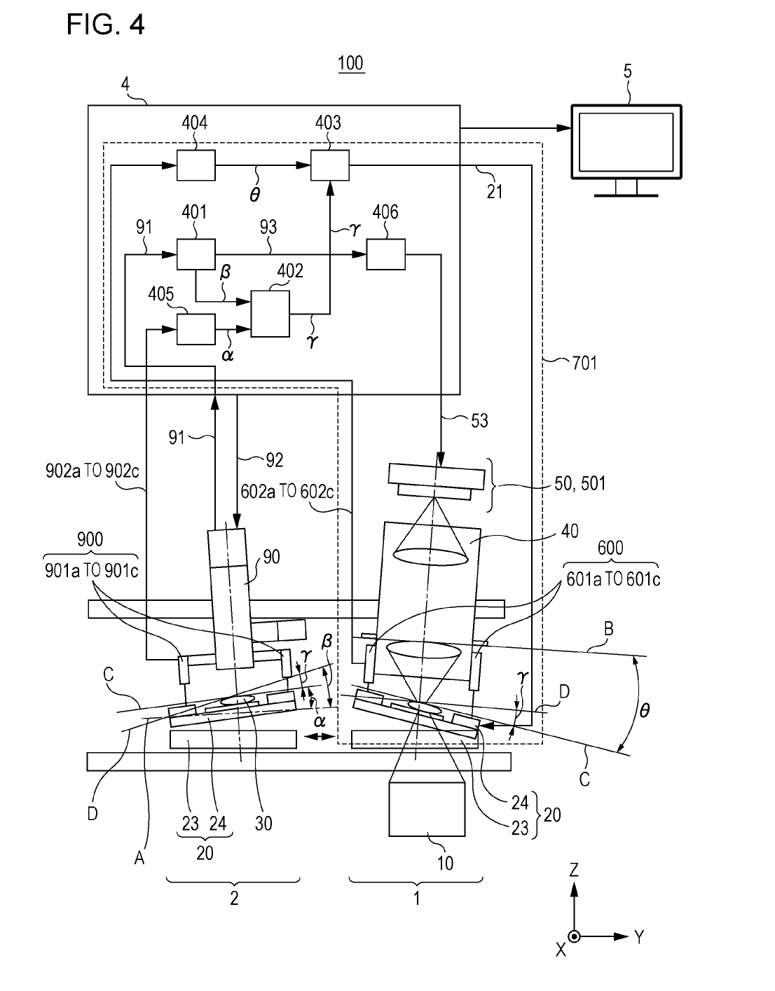

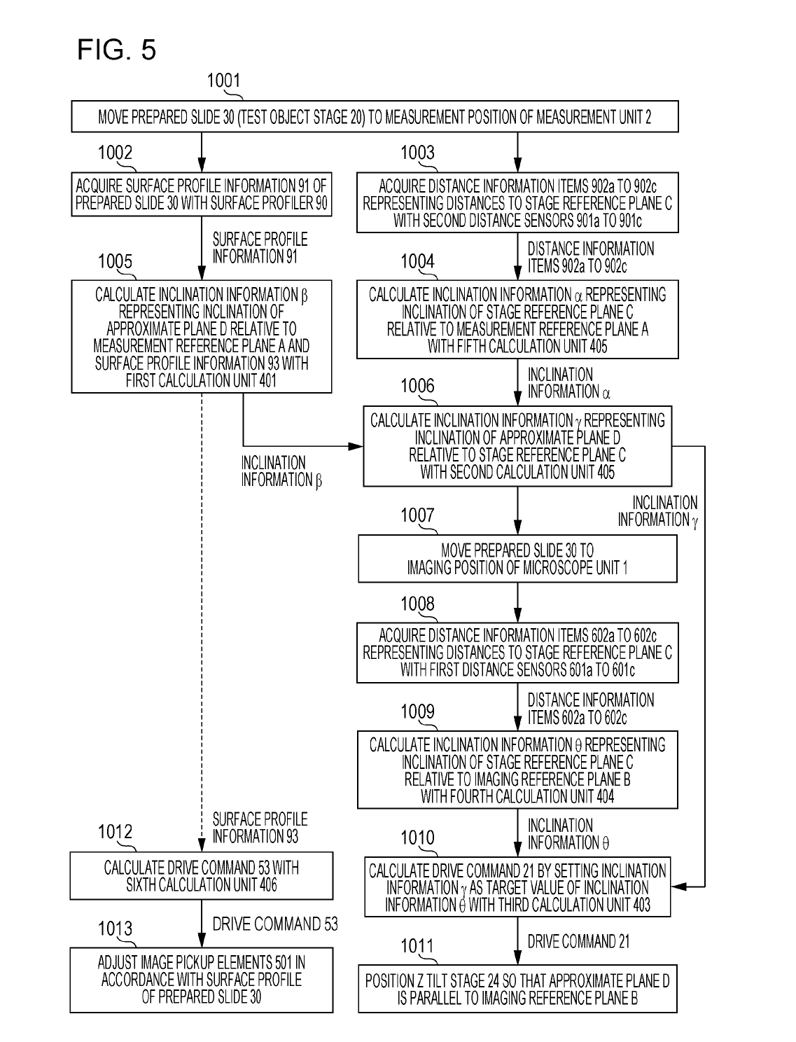

FIG. 4 is a schematic diagram illustrating the main part of the image acquisition apparatus 100 for explaining an inclination information measurement performed by the calculation processing unit 4 according to the present embodiment. As illustrated in FIG. 4, the measurement unit 2 according to the present embodiment includes the second measuring means 900 for obtaining inclination information representing an inclination of the Z tilt stage 24 relative to the surface profiler 90. In the present embodiment, the second measuring means 900 includes three second distance sensors 901a to 901c (only two of them are shown in FIG. 4). The calculation processing unit 4 includes first to sixth calculation units 401 to 406, each of which performs various calculation processes described below. The surface profiler 90, the objective optical system 40, and the imaging unit 50 are displaced from the designed positions owing to, for example, installation errors and temperature variation. Specifically, assume that a measurement reference plane A of the surface profiler 90 and an imaging reference plane B of the objective optical system 40 are both inclined relative to the designed positions thereof. In the present embodiment, the measurement reference plane A is assumed to be a plane perpendicular to an optical axis of the surface profiler 90. However, the measurement reference plane A may instead be set so as to be at a predetermined angle with respect to the optical axis. The imaging reference plane B is a plane used as a reference when the objective optical system 40 is assembled, and is assumed to be a plane perpendicular to the optical axis of the objective optical system 40. Therefore, the imaging reference plane B may be used as a reference plane of the orientation of the objective optical system 40. A method for adjusting the test object stage 20 will be described in detail with reference to a flowchart illustrated in FIG. 5.

First, a method of inclination information measurement performed in the measurement unit 2 will be described. Here, it is assumed that second test-object inclination information (inclination information γ), which represents an inclination of the approximate plane D of the surface of the cover glass 301 relative to a stage reference plane C, is acquired. The stage reference plane C is a top surface (or a surface parallel to the top surface) of the Z tilt stage 24.

First, the XY stage 23 moves the prepared slide 30 to the measurement unit 2 (S1001). Subsequently, the surface profiler 90 in the measurement unit 2 acquires the surface profile information 91 of the surface of the cover glass 301 (S1002). In the measurement unit 2, the second distance sensors 901a to 901c respectively acquire distance information items 902a to 902c representing distances to the stage reference plane C of the Z tilt stage 24 (S1003). Then, the fifth calculation unit 405 calculates first stage inclination information (inclination information α) representing an inclination of the stage reference plane C relative to the measurement reference plane A on the basis of the positional relationship between the second distance sensors 901a to 901c and the distance information items 902a to 902c (S1004). The inclination information α includes an angle αx around the X-axis and an angle αy around the Y-axis (angle αx is illustrated in FIG. 4).

Next, the first calculation unit 401 calculates the approximate plane D of the surface of the cover glass 301, first test-object inclination information (inclination information β) representing an inclination of the approximate plane D relative to the measurement reference plane A of the surface profiler 90, and surface profile information 93 (S1005). The approximate plane D can be calculated by, for example, the method of least squares from the surface profile information 91 obtained in step S1002. The inclination information β includes an angle βx around the X-axis and an angle βy around the Y-axis. The surface profile information 93 is obtained by subtracting the inclination information β from the surface profile information 91 obtained by the surface profiler 90, and is used to adjust the image pickup elements 501 (details will be described below).

The inclination information β acquired in step S1005 includes the inclination information α. Therefore, the second calculation unit 402 calculates the second test-object inclination information (inclination information γ) representing the inclination of the approximate plane D relative to the stage reference plane C by subtracting the inclination information α from the inclination information β (S1006). The inclination information γ includes an angle γx around the X-axis and an angle γy around the Y-axis. By the above-described steps, the inclination information γ representing the inclination of the approximate plane D of the surface of the cover glass 301 relative to the stage reference plane C of the Z tilt stage 24 is acquired.

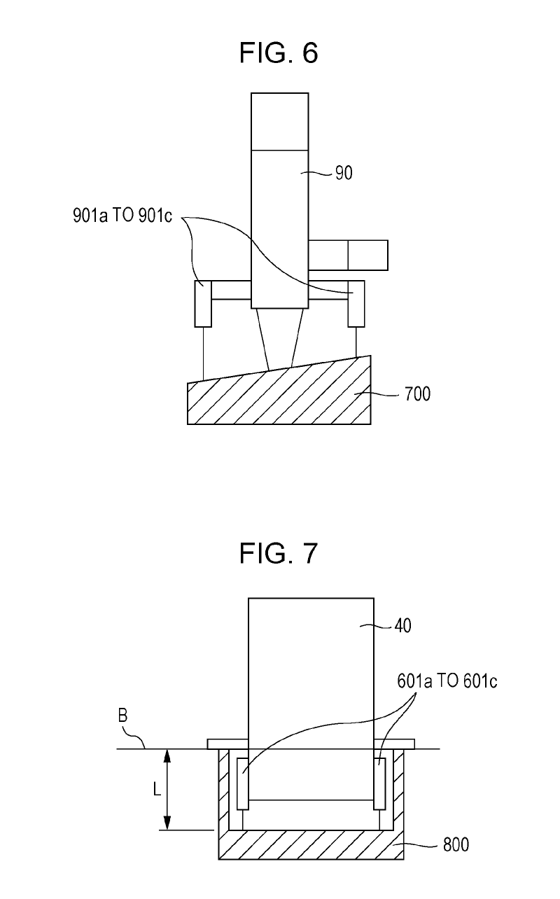

It is desirable to calibrate the surface profiler 90 and the second measuring means 900 in advance to acquire an accurate value of the inclination information γ (the inclination information α and the inclination information β). Accordingly, as illustrated in FIG. 6, a distance to a common plane of a calibration standard 700 may be measured by using both of the surface profiler 90 and the second distance sensors 901a to 901c, and offset values for making the measurement results equal to each other may be set for one or both of the measurement results.

Next, a method of inclination information measurement and a method for adjusting the test object stage 20 in the microscope unit 1 will be described.

First, the XY stage 23 moves the prepared slide 30 from the measurement unit 2 to the microscope unit 1 (S1007). As illustrated in FIG. 4, the microscope unit 1 according to the present embodiment includes the first measuring means 600 for obtaining inclination information representing an inclination of the Z tilt stage 24 relative to the objective optical system 40. In the present embodiment, the first measuring means 600 includes three first distance sensors 601a to 601c (only two of them are shown in FIG. 4).

The first distance sensors 601a to 601c respectively acquire distance information items 602a to 602c representing distances to the stage reference plane C of the Z tilt stage 24 (S1008). Then, the fourth calculation unit 404 calculates second stage inclination information (inclination information θ) representing an inclination of the stage reference plane C relative to the imaging reference plane B on the basis of the positional relationship between the first distance sensors 601a to 601c and the distance information items 602a to 602c (S1009). The inclination information θ includes an angle θx around the X-axis and an angle θy around the Y-axis.

As illustrated in FIG. 4, feedback control of the Z tilt stage 24 is performed by a first control system 701 in the microscope unit 1. The first control system 701 uses the inclination information γ of the approximate plane D as the target value for the inclination information θ of the stage reference plane C. The third calculation unit 403 calculates a drive command 21 for making the inclination information θ equal to the inclination information γ (S1010). The drive command 21 is transmitted to driving means (not shown) of the Z tilt stage 24, so that the approximate plane D is positioned to be parallel to the imaging reference plane B of the objective optical system 40 (perpendicular to the optical axis of the objective optical system 40) (S1011).

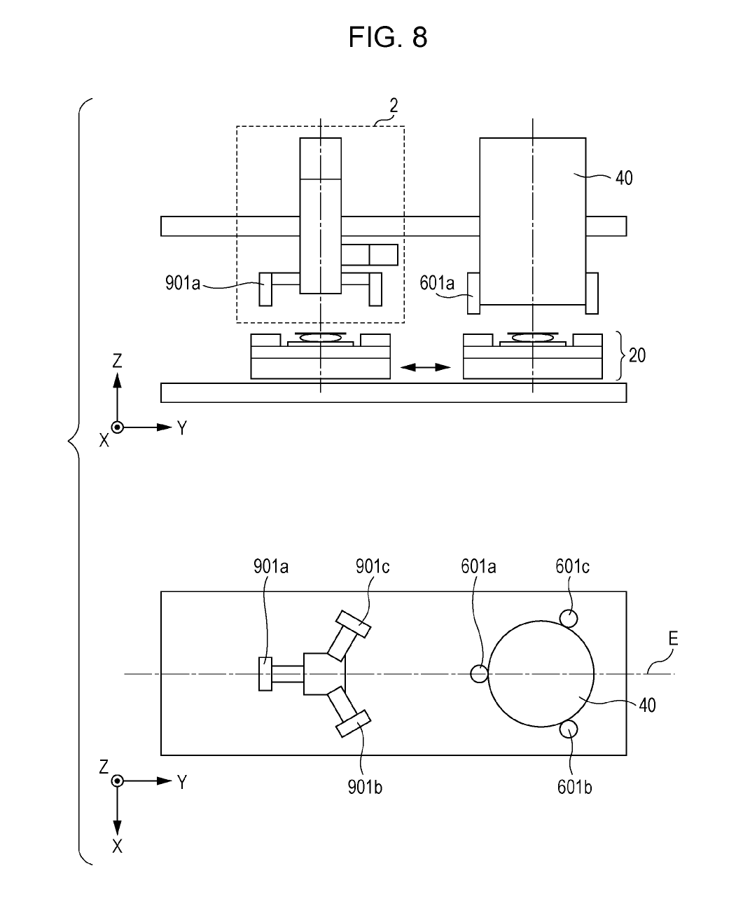

It is desirable to calibrate the first measuring means 600 in advance to acquire an accurate value of the inclination information θ. Accordingly, as illustrated in FIG. 7, a calibration jig 800 having a certified accuracy is arranged so as to abut on the imaging reference plane B of the objective optical system 40. Then, offset values for the distance information items 602a to 602c are set so that the values of the distance information items 602a to 602c output from the three first distance sensors 601a to 601c are equal to the height L of the calibration jig 800 that is measured in advance. Thus, the three first distance sensors 601a to 601c are calibrated so that the absolute distances from the imaging reference plane B of the objective optical system 40 can be measured.

As described above, the Z tilt stage 24 can be adjusted to position the approximate plane D of the surface of the cover glass 301 to be perpendicular to the optical axis of the objective optical system 40. In other words, the focus adjustment can be performed in the microscope unit 1 on the basis of not only the displacements of the components due to, for example, installation errors of the components and temperature variation, but also the surface profile of the cover glass 301. Accordingly, blurring due to defocusing can be suppressed and a satisfactory digital image can be acquired.

### Second Embodiment

In the first embodiment, the approximate plane D of the surface of the cover glass 301 of the prepared slide 30 is positioned to be parallel to the imaging reference plane B of the objective optical system 40 by adjusting the orientation of the Z tilt stage 24 of the test object stage 20. In the case where, for example, it is necessary to perform a focus position adjustment at a higher accuracy or the thickness of the cover glass 301 of the prepared slide 30 is considered, the positions of the test object stage 20 in the Z and XY directions are preferably adjusted in addition to the orientation of the test object stage 20. Accordingly, in the present embodiment, the distance between the objective optical system 40 and the imaging target surface of the prepared slide 30 is controlled in accordance with the thickness of the prepared slide 30 so that the imaging target surface of the prepared slide 30 can be positioned at a best focus position.

Specifically, the first distance sensor 601a, which is one of the three first distance sensors 601a to 601c attached to the objective optical system 40 in the first embodiment, is used as a focus adjusting sensor for performing a focus position adjustment of the prepared slide 30. After the focus position adjustment is performed, the test object stage 20 is adjusted by a method similar to that according to the first embodiment. Accordingly, the focus position adjustment can be performed at a higher accuracy. In the present embodiment, structural components that are the same as or similar to those of the first embodiment are denoted by the same reference numerals, and explanations thereof are simplified or omitted.

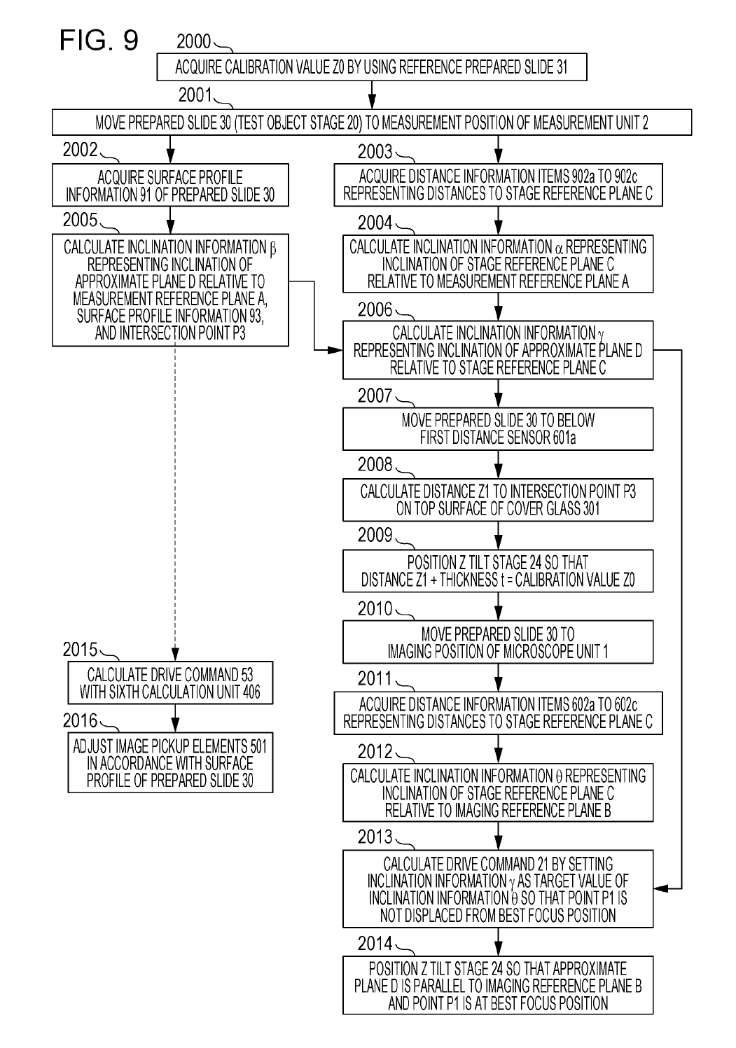

In the image acquisition apparatus 100 according to the present embodiment, the measurement unit 2 measures the prepared slide 30, and then the test object stage 20 moves the prepared slide 30 to the microscope unit 1, which captures an image of the prepared slide 30. Therefore, to efficiently perform the focus position adjustment, it is desirable to position the first distance sensor 601a on a movement path of the test object stage 20 (between the surface profiler 90 and the objective optical system 40). According to the present embodiment, when viewed in the +Z direction as illustrated in FIG. 8, the first distance sensor 601a is positioned on a straight line E that passes through the center (optical axis) of the surface profiler 90 and the center (optical axis) of the objective optical system 40. With this structure, the moving distance of the test object stage 20 can be minimized and the overall throughput of the image acquisition apparatus 100 can be increased.

When the position of the first distance sensor 601a is largely displaced from the straight line E in the X direction, the XY stage 23 is required to have a large movable area in the X direction. Therefore, to prevent the increase in the movable area of the XY stage 23 in the X direction and reduction in the throughput, the distance from the straight line E to the first distance sensor 601a is preferably less than or equal to one-half of the movable area of the XY stage 23 in the X direction. When, for example, a slide glass having a long side whose length is 76 mm as standardized by JIS is used in the prepared slide 30, the movable area of the XY stage 23 in the X direction required to acquire the image of the entire area of the slide glass is 76 mm. When the straight line E is set as a reference, the required movable area of the XY stage 23 in each of the +X and −X directions is 38 mm, which is one-half of 76 mm. In this case, the distance from the straight line E connecting the center of the surface profiler 90 and the center of the objective optical system 40 to the first distance sensor 601a in a horizontal direction is preferably set to a value that is smaller than or equal to 38 mm in accordance with the imaging area of the prepared slide 30.

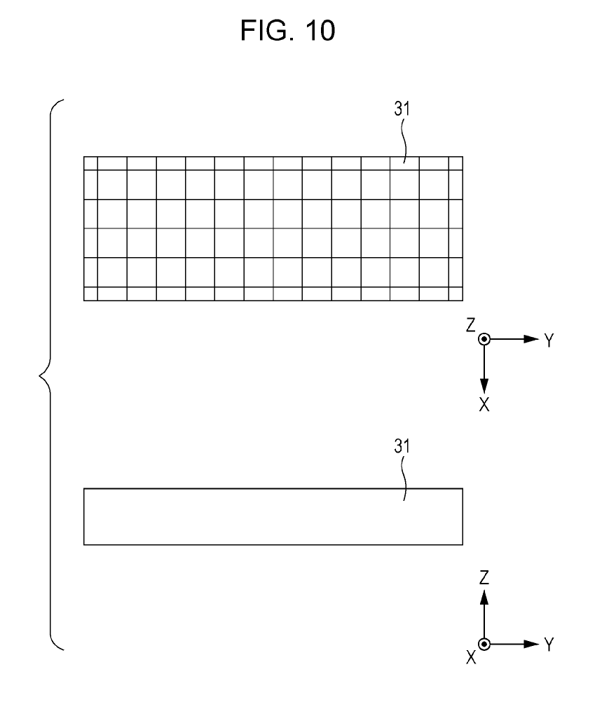

A method for adjusting the focus state of the image acquisition apparatus 100 according to the present embodiment will be described in detail with reference to a flowchart illustrated in FIG. 9.

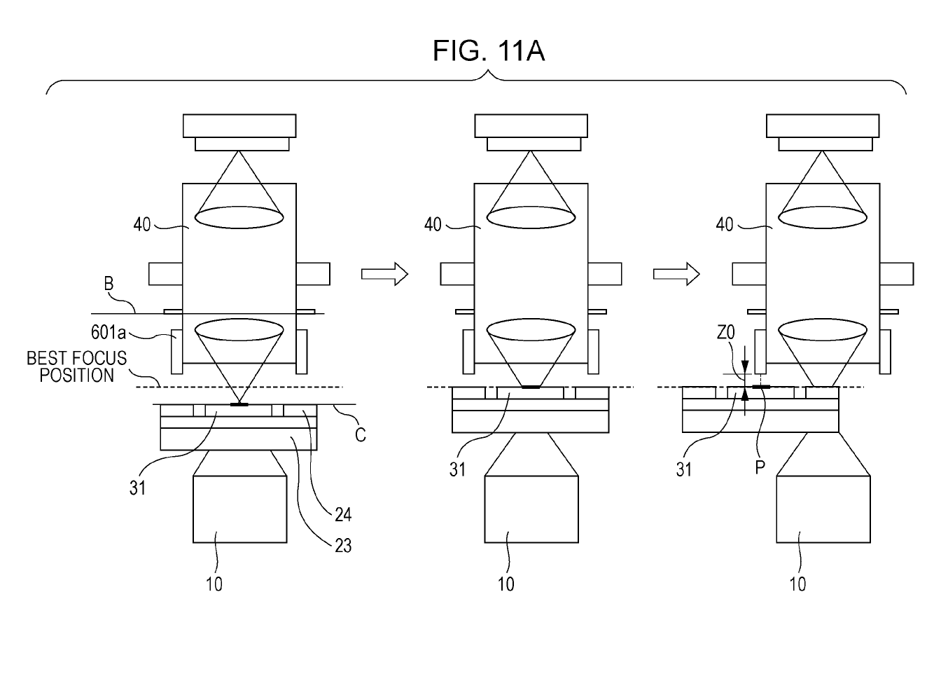

To perform the focus position adjustment of the prepared slide 30 in consideration of the thickness of the cover glass 301, calibration is preferably performed to eliminate the influence of the displacements of the components due to installation errors, temperature variation, etc., in advance. In the present embodiment, a calibration value for the position of the Z tilt stage 24 in the Z direction is acquired by using a reference prepared slide 31 illustrated in FIG. 10, and the focus position adjustment of the prepared slide 30 is performed by using the acquired calibration value. A surface of the reference prepared slide 31 is polished so as to eliminate the influence of undulation. Preferably, a grid pattern or the like is drawn on the reference prepared slide 31, as illustrated in FIG. 10, so that the focused state of the objective optical system 40 can be checked. The direction in which the Z tilt stage 24 is driven is referred to as the Z direction irrespective of whether or not there are displacements of the components.

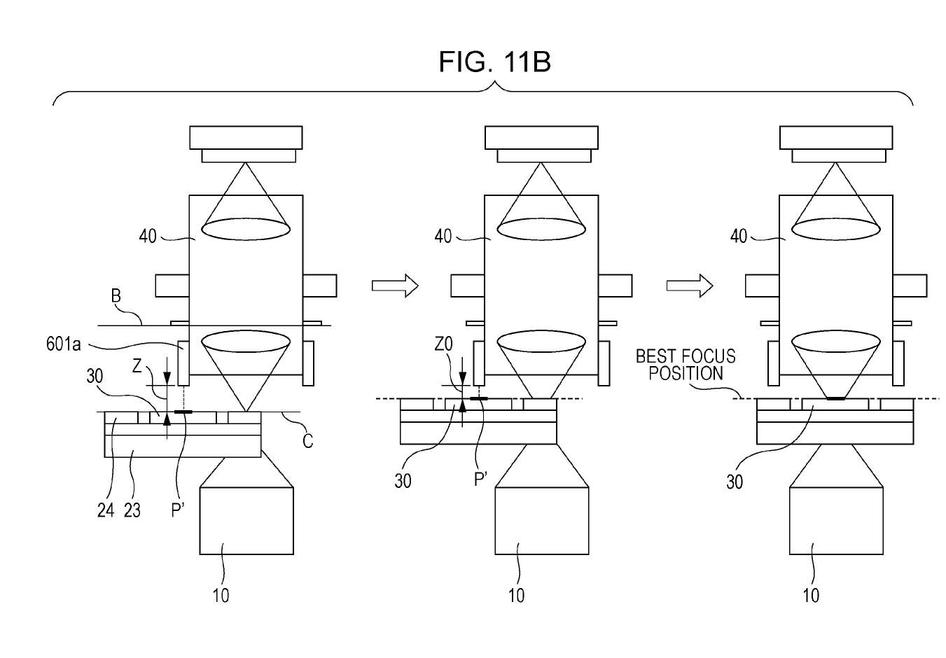

First, as illustrated in FIG. 11A, the calibration value Z0 is acquired by using the reference prepared slide 31 in step (S2000).

The reference prepared slide 31 is placed on the Z tilt stage 24, and the orientation of the Z tilt stage 24 is adjusted by an adjustment method similar to that in the first embodiment. Specifically, the Z tilt stage 24 is positioned so that the approximate plane D of the reference prepared slide 31 is parallel to the imaging reference plane B of the objective optical system 40 on the basis of the inclination information γ of the reference prepared slide 31 acquired in the measurement unit 2. The diagram in the left area of FIG. 11A shows the state in which the approximate plane D (not shown) of the reference prepared slide 31 is positioned to be parallel to the imaging reference plane B of the objective optical system 40 in the microscope unit 1.

In the case where the surface of the reference prepared slide 31 is flat and the flatness thereof is sufficiently high so that the influence of undulation can be ignored, it is not necessary to calculate the approximate plane D. In such a case, the surface of the reference prepared slide 31 itself can be used instead of the approximate plane D. In the case where the surface of the reference prepared slide 31 is flat and can be assumed to be parallel to the stage reference plane C, it is not necessary to acquire the inclination information γ of the reference prepared slide 31 in the measurement unit 2. In such a case, the Z tilt stage 24 can be adjusted so that the stage reference plane C thereof is parallel to the imaging reference plane B of the objective optical system 40 in the microscope unit 1.

Next, the Z tilt stage 24 is driven in the Z direction, and an image capturing operation is performed a plurality of times. The captured images are used to determine the best focus position of the reference prepared slide 31. Then, as illustrated in the diagram at the center of FIG. 11A, the Z tilt stage 24 is positioned so that the imaging area of the reference prepared slide 31 is on the best focus position.

Then, while the orientation and Z-direction position of the reference prepared slide 31 are not changed, only the XY stage 23 is driven so that a center point P of the imaging area of the reference prepared slide 31 is positioned at a measurement position of the first distance sensor 601a, which serves as the focus adjustment sensor. Referring to the diagram in the right area of FIG. 11A, the first distance sensor 601a measures the distance to the center point P, and stores the measurement value as a calibration value Z0. As in the first embodiment, the first distance sensor 601a may be calibrated so as to measure the absolute distance from the imaging reference plane B of the objective optical system 40. In such a case, the calibration value Z0 is the distance from the imaging reference plane B of the objective optical system 40 to the center point P of the reference prepared slide 31 at the best focus position. After the calibration value Z0 is acquired in step S2000 as described above, the prepared slide 30 to be observed is placed on the Z tilt stage 24 and the inclination information γ is calculated in a manner similar to that in the first embodiment (S2001 to S2006).

A method for positioning the surface of the prepared slide 30 at the best focus position will now be described with reference to FIG. 11B.

First, the prepared slide 30 is placed on the Z tilt stage 24, and the XY stage 23 is positioned so that the center point P′ of the imaging area on the surface of the prepared slide 30 is at the measurement position of the first distance sensor 601a, as illustrated in the diagram in the left area of FIG. 11B (S2007). Then, as illustrated in the diagram at the center of FIG. 11B, the Z tilt stage 24 is positioned so that the distance Z to the center point P′ measured by the first distance sensor 601a is equal to the calibration value Z0 that has been acquired in advance. Lastly, as illustrated in the diagram in the right area of FIG. 11B, the XY stage 23 is driven so as to move the prepared slide 30 to the imaging position. Thus, the center point P′ can be positioned at the best focus position of the objective optical system 40.

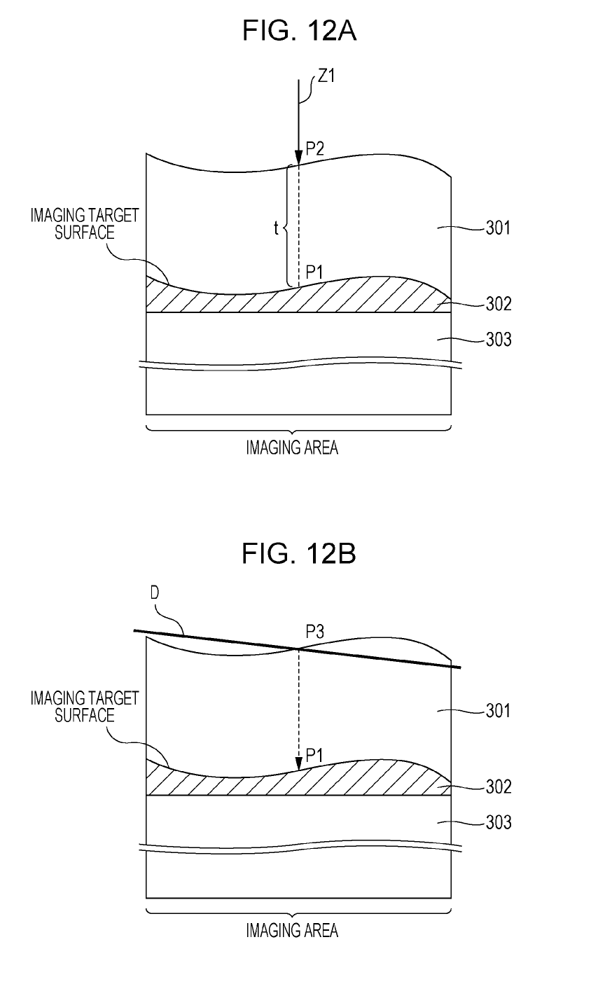

When the prepared slide 30 is the test object as in the present embodiment, the imaging target surface, which is to be observed in the imaging area, is on the surface of the sample 302 (the bottom surface of the cover glass 301), as illustrated in FIG. 12A. However, the distance Z1 measured by the first distance sensor 601a is the distance to the top surface of the cover glass 301. Therefore, to position a point P1 on the imaging target surface to the best focus position, it is necessary to adjust the Z tilt stage 24 in consideration of the thickness t of the cover glass 301. After the XY stage 23 is moved in step S2007, the first distance sensor 601a measures the distance Z1 to a point P2 (point above the point P1) on the top surface of the cover glass 301 (S2008). Then, the Z tilt stage 24 is driven to position the prepared slide 30 so that Z1+t=Z0 is satisfied (S2009). Then, the XY stage 23 is driven so as to move the prepared slide 30 to the imaging position, so that the point P1 on the imaging target surface can be positioned at the best focus position of the objective optical system 40 (S2010).

A method for determining the position of the point P1 on the imaging target surface in the XY directions will be described. Referring to FIG. 12B, the imaging target surface of the prepared slide 30 is in close contact with the bottom surface of the cover glass 301. Therefore, the profile of the imaging target surface can be assumed as being similar to the profile of the bottom surface of the cover glass 301. In the present embodiment, the position of the point P1 on the imaging target surface is determined on the basis of the surface profile of the cover glass 301. First, similar to the first embodiment, the first calculation unit 401 calculates the approximate plane D of the cover glass 301 in step S2005. In this step, an intersection point P3, which is illustrated in FIG. 12B, between the top surface of the cover glass 301 and the approximate plane D is also calculated. Since the profile of the imaging target surface can be assumed to be similar to the surface profile of the cover glass 301, the position of the intersection point P3 in the XY directions is acquired as the position of the point P1 in the XY directions. Thus, the position of the point P1 on the imaging target surface is determined. When the point P1 is displaced from the center of the imaging target surface, the amount by which the XY stage 23 is driven to move the prepared slide 30 from the measurement position of the first distance sensor 601a to the imaging position under the objective optical system 40 is preferably adjusted in accordance with the amount of the displacement.

In the present embodiment, the point P1 on the imaging target surface is positioned at the best focus position of the objective optical system 40 by the above-described method. Then, the approximate plane D of the surface of the cover glass 301 is positioned to be parallel to the imaging reference plane B of the objective optical system 40 (perpendicular to the optical axis). Specifically, the inclination information θ representing the inclination of the stage reference plane C of the Z tilt stage 24 relative to the imaging reference plane B of the objective optical system 40 is calculated by a method similar to that used in steps S1008 and S1009 in the first embodiment (S2011 and S2012). When the orientation of the Z tilt stage 24 is adjusted in the microscope unit 1, the point P1 on the imaging target surface that is positioned at the best focus position is preferably prevented from being displaced from the best focus position. Therefore, the third calculation unit 403 calculates the drive command 21 on the basis of the distance information items 602a to 602c from the first distance sensors 601a to 601c so that the position of the Z tilt stage 24 is controlled while the point P1 on the imaging target surface does not move from the best focus position (S2013). The position of the Z tilt stage 24 is controlled in accordance with the drive command 21 so that the inclination information θ is equal to the inclination information γ (S2014).

As described above, the test object stage 20 can be adjusted so that the approximate plane D of the surface of the cover glass 301 is positioned to be perpendicular to the optical axis of the objective optical system 40, and so that the point P1 on the imaging target surface of the prepared slide 30 is positioned at the best focus position of the objective optical system 40. In other words, the focus adjustment can be performed in the microscope unit 1 in accordance with the displacements of the components due to installation errors, temperature variation, etc., and the surface profile of the cover glass 301. Accordingly, blurring due to defocusing can be suppressed and a satisfactory digital image can be acquired.

### Other Embodiments

Although preferred embodiments of the present invention have been described, it goes without saying that the present invention is not limited to the embodiments and various modifications and alterations are possible within the scope of the present invention. For example, in the first and second embodiments, the focus adjustment is performed by using only the test object stage 20. However, with regard to a small undulation of the cover glass 301, the image pickup elements 501 included in the imaging unit 50 may be driven so as to adjust the focus. In such a case, the sixth calculation unit 406 calculates a drive command 53 on the basis of the surface profile information 93 acquired in step S1005 of FIG. 5 or in step S2005 of FIG. 9 (S1012 or 2015). The drive command 53 is transmitted to each of the image pickup elements 501, and the drive mechanisms 502 are driven in accordance with the drive command 53, so that each image pickup element 501 can be positioned in accordance with the surface profile of the cover glass 301 (S1013 or 2016). By adjusting the test object stage 20 and the image pickup elements 501, an image that is in focus over the entire imaging area of the prepared slide 30 can be obtained.

In each of the above-described embodiments, the second measuring means 900 includes the second distance sensors 901a to 901c and the first measuring means 600 includes the first distance sensors 601a to 601c. However, the structure of each measuring means is not limited to this. As long as the above-described inclination information can be acquired from the measurement information obtained by the measuring means, the number of the distance sensors is not limited to three. Alternatively, sensors other than the distance sensors may be used as the measuring means.

In the first embodiment, the inclination information γ is used as the target value of the inclination information θ representing the inclination of the stage reference plane C of the Z tilt stage 24 relative to the imaging reference plane B of the objective optical system 40. However, a more suitable target value may be set in accordance with the surface profile of the cover glass.

According to the present invention, an image acquisition apparatus is provided which includes a wide-field, high-resolution objective optical system and which is capable of acquiring a satisfactory digital image of a sample by suppressing blurring due to defocusing even when the sample has an undulated surface.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Patent Application No. PCT/JP2011/078520, filed Dec. 9, 2011, which is hereby incorporated by reference herein in its entirety.

1. An image acquisition apparatus comprising:
a test object stage that holds a test object;
a measuring unit that acquires surface profile information of the test object; and
a microscope unit that includes an objective optical system that forms an image of the test object and an image pickup element that captures the image of the test object formed by the objective optical system,
wherein the test object stage is movable between a measurement position of the measuring unit and a imaging position of the microscope unit,
wherein the measuring unit acquires first stage inclination information of the test object stage, and
wherein, at the imaging position, the test object stage adjusts an orientation thereof on the basis of a relationship between the surface profile information and the first stage inclination information.

2. The image acquisition apparatus according to claim 1, further comprising a calculation processing unit that calculates an approximate plane of a surface of the test object on the basis of the surface profile information,
wherein, at the imaging position, the test object stage adjusts the orientation thereof on the basis of a relationship between the approximate plane and the first stage inclination information so that the approximate plane is perpendicular to an optical axis of the objective optical system.

3. The image acquisition apparatus according to claim 2,
wherein the calculation processing unit performs
a process of calculating first test-object inclination information of the approximate plane on the basis of the surface profile information,
a process of calculating second test-object inclination information of the approximate plane on the basis of the first stage inclination information and the first test-object inclination information, and
a process of calculating a drive command for adjusting the orientation of the test object stage so that second stage inclination information of the test object stage in the imaging position is equal to the second test-object inclination information.

4. The image acquisition apparatus according to claim 3, wherein the first test-object inclination information represents an inclination of the approximate plane relative to a measurement reference plane of the measuring unit and the second test-object inclination information represents an inclination of the approximate plane relative to the test object stage, and
wherein the first stage inclination information represents an inclination of the test object stage relative to the measurement reference plane and the second stage inclination information represents an inclination of the test object stage relative to an imaging reference plane that is perpendicular to the optical axis of the objective optical system.

5. The image acquisition apparatus according to claim 4, wherein the microscope unit includes a first distance sensor that measures a distance to a top surface of the test object stage and that is offset so that the distance measured by the first distance sensor is a distance from the imaging reference plane.

6. The image acquisition apparatus according to claim 5, wherein the first distance sensor is provided in a plurality, and one of the plurality of first distance sensors serves as a focus adjustment sensor that is disposed between the objective optical system and the measuring unit.

7. The image acquisition apparatus according to claim 6, wherein the test object includes a cover glass and a sample that is in contact with the cover glass,
wherein the focus adjustment sensor acquires distance information representing a distance from the imaging reference plane to an intersection point between a surface of the cover glass and the approximate plane, and
wherein a position of the test object stage is adjusted so that the sum of the distance information and a thickness of the cover glass is equal to a distance from the imaging reference plane to a best focus position of the objective optical system.

8. The image acquisition apparatus according to claim 6, wherein a distance in a horizontal direction between a position at which the focus adjustment sensor is disposed and a straight line that connects an optical axis of the objective optical system and an optical axis of the measuring unit is smaller than or equal to one-half of a movable range of the test object stage in a direction perpendicular to the straight line.

9. The image acquisition apparatus according to claim 1, wherein the measuring unit includes a surface profiler that acquires the surface profile information and a second distance sensor that measures a distance to a top surface of the test object stage, and the surface profiler and the second distance sensor are both offset so as to measure a common plane.

10. The image acquisition apparatus according to claim 1, wherein the microscope unit includes a drive mechanism capable of changing at least one of a position and an orientation of the image pickup element.

11. The image acquisition apparatus according to claim 1, wherein the microscope unit includes a plurality of the image pickup elements.

12. A method for adjusting an image acquisition apparatus, the method comprising:
a step of placing a test object on a top surface of a test object stage;
a step of acquiring surface profile information of the test object and first stage inclination information of the test object stage with a measuring unit; and
a test-object-stage adjusting step of adjusting an orientation of the test object stage on the basis of a relationship between the surface profile information and the first stage inclination information in a imaging position of a microscope unit.

13. The method for adjusting the image acquisition apparatus according to claim 12, further comprising:
an inclination information measuring step including a sub-step of calculating an approximate plane of a surface of the test object on the basis of the surface profile information and a sub-step of acquiring second test-object inclination information representing an inclination of the approximate plane relative to the test object stage,
wherein the test-object-stage adjusting step is a step of adjusting the orientation of the test object stage so that second stage inclination information, which represents an inclination of the test object stage relative to an imaging reference plane that is perpendicular to an optical axis of the microscope unit, is equal to the second test-object inclination information.

14. The method for adjusting the image acquisition apparatus according to claim 13,
wherein the inclination information measuring step further includes
a sub-step of acquiring first test-object inclination information representing an inclination of the approximate plane relative to a measurement reference plane of the measuring unit, and
a sub-step of acquiring the second test-object inclination information on the basis of the first stage inclination information and the first test-object inclination information.

15. The method for adjusting the image acquisition apparatus according to claim 13, further comprising a step of acquiring distance information representing a distance from the imaging reference plane to an intersection point between a surface of a cover glass included in the test object and the approximate plane and adjusting a position of the test object stage so that the sum of the distance information and a thickness of the cover glass is equal to a distance from the imaging reference plane to a best focus position in the microscope unit.
